(19) United States
(12) Patent Application Publication
(10) Pub. No.: US 2014/0314943 A1
(43) Pub. Date: Oct. 23, 2014

(54) SALT COMPOSITION

(71) Applicant: Dow Global Technologies LLC, Midland, MI (US)

(72) Inventor: Anne Adden, Walsrode (DE)

(73) Assignee: Dow Global Technologies LLC, Midland, MI (US)

(21) Appl. No.: 14/359,939

(22) PCT Filed: Dec. 4, 2012
(86) PCT No.: PCT/US2012/067666

§ 371 Date: May 22, 2014

Related U.S. Application Data
(60) Provisional application No. 61/568,326, filed on Dec. 8, 2011.

(51) Int. Cl. A23L 1/237

(52) U.S. Cl. CPC A23L 1/237
USPC 426/649

(57) ABSTRACT

A salt composition consisting of an alkali metal chloride, a carboxymethyl cellulose and 0 to 90% of other ingredients, wherein the carboxymethyl cellulose, has a viscosity of from 200 to 15,000 mPa-s, measured as a 2 weight percent aqueous solution at 20° C. using a Haake RS 1 viscometer with a cylinder system Z34 DIN at 10.0 s⁻¹. The carboxymethyl cellulose can be used for increasing the perceived saltiness provided by an alkali metal chloride, such as sodium chloride, or for reducing the amount of an alkali metal chloride, such as sodium chloride in a fluid or solid food composition.

### FIELD

The present invention concerns salt compositions and a method of increasing the perception of saltiness for a given salt level or of reducing the amount of salt in food compositions.

### INTRODUCTION

Hypertension (elevated blood pressure), which is an important risk factor for stroke and heart diseases, has been shown to be related to intake of salt (NaCl, sodium chloride). Accordingly, reduction of sodium chloride levels in foods is an important public health objective. Public health and regulatory authorities, such as the World Health Organisation (WHO) and the Food and Drug Administration, recommend lowering the dietary intake of salt (NaCl) and salt reduction programs have been initiated. Unfortunately, there is no known good alternative material to sodium chloride that gives the same taste. Potassium chloride has been used to replace sodium chloride, because it has been reported that both sodium and chloride ions must be ingested to induce elevated blood pressure (hypertension). However, potassium chloride has a bitter taste. Therefore, the amount of potassium chloride used to replace sodium chloride should also be minimized Also, for low molecular weight salts the order of decreasing saltiness is chlorides, bromides, iodides, sulphates and nitrates. Therefore it is important to ensure that the perception of saltiness is maximized for a given salt level.

Much effort has been spent by the skilled artisans to find ways of reducing the amount of sodium chloride in food while still maintaining the perceived saltiness which is preferred by many consumers.

Food hydrocolloids such as guar gum, cornstarch, gum tragacanth, carboxymethyl cellulose, methylcellulose, and pectin are well-known thickeners, but they do not provide a salty taste on their own. Their effect on the four primary tastes sweetness (saccharose or sodium saccharin), sourness (citric acid), saltiness (sodium chloride) or bitterness (quinine sulfate or caffeine) in plain water has been studied by several authors.

Pangborn et al. (Effect of Hydrocolloids on Oral Viscosity and Basic Taste intensities, Journal of Texture Studies 4, (1973) 224-241) studied the impact of hydroxypropyl cellulose (HPC), xanthan, sodium alginate, and medium and low viscosity carboxymethyl cellulose (CMC) on the taste intensities of aqueous solutions of sodium chloride. The studied hydrocolloids were found to have an insignificant influence on the taste intensity of NaCl.

Others studied the influence of viscosities on the perceived saltiness of an aqueous solution. Moskowitz, H. R. and Arabie, P., Taste intensity as a function of stimulus concentration and solvent viscosity, Journal of Texture Studies, 1, 1970, 502-510, investigated how the viscosities induced by CMC affect the intensities of glucose, citric acid, sodium chloride, and quinine The authors found that increases in apparent viscosity yield decreases in the perceived taste intensity of the four substances.

More recent publications have suggested partial substitution of NaCl with other salts. U.S. Pat. No. 6,541,050 suggests the use of a combination of NaCl, KCl and sulfate-containing salts. The International Patent Application WO 2007/045566 discloses a salt substitute based on (a) one or more physiologically acceptable inorganic salts which are not sodium chloride (b) one or more monovalent or polyvalent salts of polybasic food acids and (c) one or more amino acids suitable for nutrition or salts thereof. However, these low molecular weight salts have the disadvantages discussed further above, i.e., bitterness in the case of potassium chloride or lower saltiness in the case of bromide, iodide, sulphate and nitrate salts.

Other publications have suggested applying the sodium chloride on a carrier to reduce the amount of sodium chloride while maintaining the perceived saltiness in food. U.S. Pat. No. 5,094,862 discloses a free-flowing salt substitute granule based on a core composition comprising desweetened sugar and a coating on the core comprising sodium chloride. U.S. Patent Application No. 2010/0028496 discloses core particles that are wetted by fatty oils and sodium chloride that adheres to the wetted particles. The International Patent Applications WO 2008/043054 and WO 2010/139987 suggest other carriers for sodium chloride. Unfortunately, the disclosed methods for applying the sodium chloride on a carrier all require multiple productions steps which increase the cost of the sodium chloride to a large extent.

WO 2009/080423 discloses a food product having a reduced salt level, comprising 5 to 40 vol. % of a gas. Unfortunately, the use of a gas for treating the food product adds to the complexity of the food production and is limited to certain food.

Accordingly, there is an urgent need to find a new method of reducing the amount of alkali metal chlorides, particularly sodium chloride, in food compositions without substantially reducing the perceived saltiness of the food compositions.

### SUMMARY

Surprisingly, it has been found that the perceived saltiness of an alkali metal chloride, particularly sodium chloride, in fluid food compositions having a certain minimal viscosity or in solid food compositions can be increased by incorporating a medium viscosity carboxymethyl cellulose in the food composition.

Accordingly, one aspect of the present invention is a salt composition consisting of

a) an alkali metal chloride,

b) a carboxymethyl cellulose, and

c) 0 to 90 percent, based on the total weight of the salt composition, of one or more additional ingredients,

wherein the carboxymethyl cellulose has a viscosity of from 200 to 15,000 mPa•s, measured as a 2 weight percent aqueous solution at 20° C. using a Haake RS 1 viscometer with a cylinder system Z34 DIN at 10.0 s⁻¹ and the weight ratio of [carboxymethyl cellulose/alkali metal chloride] is from [0.2/1.0] to [4.0/1.0].

Another aspect of the present invention is a method of increasing the perceived saltiness provided by an alkali metal chloride in a fluid or solid food composition which comprises the step of incorporating a carboxymethyl cellulose having a viscosity of from 200 to 15,000 mPa•s, measured as a 2 weight percent aqueous solution at 20° C. using a Haake RS1 viscometer with a cylinder system Z34 DIN at 10.0 s⁻¹, in combination with an alkali metal chloride in the fluid or solid food composition in such amount that the weight ratio [carboxymethyl cellulose/alkali metal chloride] in the food composition is from [0.1/1.0] to [4.0/1.0], with the proviso that the fluid food composition has a viscosity of at least 10 mPa•s, when measured in the absence of the carboxymethyl cellulose at 20° C. using a Haake RS1 viscometer at 10.0 s⁻¹.

Yet another aspect of the present invention is a method of reducing the amount of an alkali metal chloride in a fluid or solid food composition which comprises the steps of: incorporating a fraction of an amount of alkali metal chloride that is recommended in a given recipe for the food composition resulting in a loss of saltiness, and incorporating carboxymethyl cellulose having a viscosity of from 200 to 15,000 mPa•s, measured as a 2 weight percent aqueous solution at 20° C. using a Haake RS1 viscometer with a cylinder system Z34 DIN at 10.0 s⁻¹ in the fluid or solid food composition in such amount that the weight ratio [carboxymethyl cellulose/alkali metal chloride] in the food composition is from [0.1/1.0] to [4.0/1.0] to compensate for the lost perception of saltiness, with the proviso that the fluid food composition has a viscosity of at least 10 mPa•s, when measured in the absence of the carboxymethyl cellulose at 20° C. using a Haake RS 1 viscometer at 10.0 s⁻¹.

Yet another aspect of the present invention is the use of a carboxymethyl cellulose having a viscosity of from 200 to 15,000 mPa•s, measured as a 2 weight percent aqueous solution at 20° C. using a Haake RS1 viscometer with a cylinder system Z34 DIN at 10.0 s⁻¹, for increasing the perceived saltiness provided by an alkali metal chloride in i) a fluid food composition having a viscosity of at least 10 mPa•s, when measured in the absence of the carboxymethyl cellulose at 20° C. using a Haake RS1 viscometer at 10.0 s⁻¹, or ii) in a solid food composition.

### DETAILED DESCRIPTION

The salt composition of the present invention consists of a) an alkali metal chloride, b) carboxymethyl cellulose, and optionally c) one or more additional ingredients.

Preferred alkali metal chlorides are sodium chloride and potassium chloride. Sodium chloride is the most preferred alkali metal chloride.

Useful types of carboxymethyl cellulose (CMC) include their salts, preferably their sodium and potassium salts. The CMC is typically used in the form of its sodium salt. Preferred types of CMC have a DS of from 0.4 to 1.4, more preferably of from 0.6 to 1.0, and most preferably of from 0.7 to 0.9. The term “DS” refers to the degree of carboxymethyl substitution per anhydroglucose unit and means the average number of OH groups substituted with carboxymethyl groups per anhydroglucose unit. The DS is measured according to ASTM D 1439-03 “Standard Test Methods for Sodium Carboxymethylcellulose; Degree of Etherification, Test Method B: Nonaqueous Titration”. The CMC can be present in various forms in the salt composition of the present invention, such as in powder form or in the form of agglomerates when the salt composition is in solid form. A way of producing CMC in the form of agglomerates is described in the International Patent Publication WO 2010/117781.

The CMC has a viscosity of up to 15,000 mPa•s, typically up to 10,000 mPa•s, preferably up to 5000 mPa•s, more preferably up to 3000 mPa•s, most preferably up to 2000 mPa•s, and particularly up to 1500 mPa•s, measured as a 2 weight percent aqueous solution at 20° C. using a Haake RS1 viscometer with a cylinder system Z34 DIN at 10.0 s⁻¹. The Haake RS 1 viscometer is commercially available as HAAKE RheoStress® 1 from Thermo Electron (Karlsruhe GmbH), Germany. The viscosity of the CMC is 200 mPa•s or more, preferably 300 mPa•s or more, more preferably 400 mPa•s or more, and most preferably 500 mPa•s or more, when measured as indicated above.

It has been surprisingly found that when using CMC which has a viscosity of from 200 to 15,000 mPa•s in food compositions, generally lower amounts are needed to increase the perceived saltiness of an alkali metal chloride, particularly sodium chloride, or to reduce the amount of an alkali metal chloride without substantially reducing the perceived saltiness than when using CMC of less than 200 mPa•s.

The weight ratio [carboxymethyl cellulose/alkali metal chloride] in the salt composition of the present invention is at least 0.2/1.0, preferably at least 0.3/1.0, more preferably at least 0.4/1.0, and most preferably at least 0.5/1.0. The weight ratio [carboxymethyl cellulose/alkali metal chloride] is up to 4.0/1.0, preferably up to 3.0/1.0, more preferably up to 2.0/1.0, and most preferably up to 1.5/1.0. The salt composition of the present invention can comprise more than one type of CMC's and/or more than one type of alkali metal salts, but their total weight should be within the ranges stated above.

The total weight of the alkali metal chloride and the carboxymethyl cellulose in the salt composition of the present invention is at least 10 percent, typically at least 20 percent, more typically at least 25 percent, preferably at least 50 percent, more preferably at least 60 percent, most preferably at least 80 percent, and particularly at least 90 percent, based on the total weight of the salt composition.

The salt composition of the present invention optionally comprises c) up to 90 percent, typically up to 80 percent, more typically up to 75 percent, preferably up to 50 percent, more preferably up to 40 percent, most preferably up to 20 percent, and particularly up to 10 percent of one or more additional ingredients, based on the total weight of the salt composition. If the salt composition comprises one or more additional ingredients c), their total amount is typically 0.1 percent or more, alternatively 1 percent or more, or in some aspects of the invention 5 percent or more, based on the total weight of the salt composition. The optional additional ingredient c) is different from alkali metal chloride and carboxymethyl cellulose. Optional additional ingredients are, for example, liquids like water; herbs, flavoring agents, such as spices like curry, pepper or paprika, just to name a few; antioxidants, such as rosemary extract; or colorants, such as caramel color, beta-carotene, or paprika oleoresin.

Examples of useful herbs are culinary herbs, such as thyme, rosemary, basil, oregano, or lavender, dill weed or dill seed, coriander leaves or seeds, sage or parsley. Examples of useful flavoring agents are spice oleoresins, for example derived from garlic, majoram, paprika or pepper; essential oils, such as onion oil, rosemary oil or citrus oils; botanical flavor extracts, such as chicory root; or protein hydrolysates, such as hydrolyzed vegetable protein, meat protein hydrolyzates or milk protein hydrolyzates, or glutamates, such as the monosodium salt of glutamic acid. Natural and man-made compounded flavours include those disclosed in S. Heath, Source Book of Flavours, Avi Publishing Co., Westport, Conn., 1981, pp. 149-277.

It has been surprisingly found that by incorporating a CMC described above in fluid food compositions having a certain minimal viscosity or in solid food compositions, the perception of saltiness provided by an alkali metal chloride is significantly increased in these compositions or alternatively the amount of an alkali metal chloride can be significantly reduced while maintaining the perceived saltiness of these compositions. For example, in the case of sodium chloride, it has been found that the amount of sodium chloride in these compositions can generally be decreased by at least 10 percent, typically by at least 20 percent or even by at least 25 percent while maintaining the perceived saltiness of these compositions. This finding is surprising in view of the fact that skilled artisans have found that the viscosities induced by CMC decreases the perceived taste intensity of sodium chloride in plain water (Moskowitz, H. R. and Arabie, P., Taste intensity as a function of stimulus concentration and solvent viscosity, Journal of Texture Studies, 1, 1970, 502-510) or have found that CMC does not have a significant influence on the taste intensity of NaCl in plain water (Pangborn et al., Effect of Hydrocolloids on Oral Viscosity and Basic Taste intensities, Journal of Texture Studies 4, 1973, 224-241). Reducing the amount of alkali metal chlorides, particularly sodium chloride, in food compositions without reducing their perceived saltiness is an important problem to be solved by the food industry in view of the overconsumption of sodium chloride and the health issues created by this overconsumption. The use of a CMC for reducing the amount of sodium chloride in food compositions without reducing their perceived saltiness is particularly effective in food compositions that are designated by the skilled artisans as having a low to medium saltiness in the absence of carboxymethyl cellulose. Low saltiness in aqueous solutions is generally defined as having from 0.01to 0.5 wt. %, typically from 0.05 to 0.4 wt. %, more typically from 0.1 to 0.35 wt. %, and most typically from 0.15 to 0.3 wt. % of sodium chloride, based on the total weight of the aqueous solution. Higher concentrations of sodium chloride, i.e., 0.6 wt. % or more in aqueous solutions are generally perceived as being very salty and panelists have difficulties in noticing small differences in saltiness. The fluid food composition comprising an alkali metal chloride like sodium chloride can be, e.g., liquid or gel-type, e.g. spoonable or spreadable. It should have a viscosity of at least 10 mPa•s, preferably at least 100 mPa•s, and more preferably at least 500 mPa•s, when measured in the absence of the carboxymethyl cellulose at 20° C. using a Haake RS1 viscometer at 10.0 s⁻¹. The fluid food composition typically has a viscosity of up to 50,000 mPa•s, more typically up to 35,000 mPa•s, most typically up to 25,000 mPa•s, and in particular up to 10,000 mPa•s when measured in the absence of the carboxymethyl cellulose using a Haake RS1 viscometer at 10 s⁻¹. When the viscosity of a fluid food composition is between 1 and 40,000 mPa•s, it is measured at 20° C. using a Haake RS1 viscometer with a cylinder system Z34 DIN at a shear rate of 10.0 s⁻¹. Viscosities above 40,000 mPa•s are measured at 20° C. using a Haake RS1 viscometer with a cone and plate geometry at 10 s⁻¹.

The term “fluid food composition” includes beverages, soups, sauces, spreads, dressings, desserts or mayonnaises, provided that they have a viscosity as stated above. Preferred examples of fluid food compositions are vegetable based compositions, such as processed vegetables, or fruit-and-vegetable preparations, purees, like vegetable purees, or beverages. A soup typically has a sodium chloride content of 20-800 mg/100 ml, a conventional sauce typically has a sodium chloride content of 40-1,200 mg/100 ml, and a typical savory beverage typically has a sodium chloride content of 10-500 mg/100 ml. The term “fluid food composition” as used herein also includes semi-solid food compositions, for example fermented and non fermented dairy-products comprising sodium chloride, such as quark (white cheese) or “fromage frais” or processed potato products, such as potato puree. Preferred examples of solid food compositions are baked goods comprising sodium chloride, such as bread, cakes, biscuits, salty cookies, salty rolls or muffins, or deep-fried goods, such as French fries.

Generally the carboxymethyl cellulose is incorporated into the food composition in such amount that the weight ratio [carboxymethyl cellulose/alkali metal chloride] in the food composition is at least 0.1/1.0, preferably at least 0.2/1.0, more preferably at least 0.3/1.0, and most preferably at least 0.4/1.0. Generally the carboxymethyl cellulose is incorporated into the food composition in such amount that the weight ratio [carboxymethyl cellulose/alkali metal chloride] in the food compositions is up to 4.0/1.0, preferably up to 3.0/1.0, more preferably up to 2.0/1.0, and most preferably up to 1.5/1.0. The alkali metal chloride in the food composition encompasses the amount of added alkali metal chloride as well as the amount of alkali metal chlorides that may be present in the food composition originating from natural sources, such as vegetables, eggs, fish or meat.

Preferably the carboxymethyl cellulose is incorporated into the fluid food composition in such amount that the viscosity of the fluid composition comprising the carboxymethyl cellulose is not more than 100 percent higher, more preferably not more than 50 percent higher, and most preferably not more than 20 percent higher than the viscosity of the fluid composition without the carboxymethyl cellulose. In some embodiments of the invention, particularly in food compositions of high viscosity like potato puree, no increase in viscosity is measurable due to the incorporation of the carboxymethyl cellulose into the food composition.

To achieve the above-mentioned weight ratio [carboxymethyl cellulose/alkali metal chloride] in the final food composition, carboxymethyl cellulose and alkali metal chloride are generally incorporated in the food composition at a weight ratio [carboxymethyl cellulose/alkali metal chloride] of at least 0.2/1.0, preferably at least 0.3/1.0, more preferably at least 0.4/1.0, and most preferably at least 0.5/1.0. Generally the weight ratio between added carboxymethyl cellulose and alkali metal chloride is up to 4.0/1.0, preferably up to 3.0/1.0, more preferably up to 2.0/1.0, and most preferably up to 1.5/1.0.

Some embodiments of the invention will now be described in detail in the following Examples.

### EXAMPLES

Unless otherwise mentioned, all parts and percentages are by weight. In the Examples the following test procedures were used.

### Sensory Evaluation: Triangular Test According to ISO 4120:2001

The sensory evaluation was based on the requirements of the international standard ISO 4120:2004.

This method is effective for determining that a perceptible difference results (test for difference) or a perceptible difference does not result (test for similarity) between two samples A and B. Assessors receive a set of three samples (i.e. a triad) and are informed that two of the samples are alike and one is different (designated as odd sample). The assessors report which sample they believe to be different even if the selection is based only on a guess (forced-choice-test). That means the report “no difference” is not allowed in this test. A minimum of 6 assessors is required for a test for difference, at least 18 assessors are necessary for a test for similarity. Replicate evaluations may be used if needed to produce a sufficient number of total evaluations.

An equal number of six possible sequences of two samples A and B is used:

ABB AAB ABA BAA BBA BAB

The samples are coded with three-digit-random numbers and distributed at random in groups of six among the assessors. Each sequence is used once among the first group of six assessors, then the next group and so on.

The triads are presented simultaneously to the assessors. They are allowed to make repeated evaluations.

In this study a test for difference was conducted. At least 6 trained assessors participated in each session. The samples were presented to them in a random order; 15 g of the sample were served. Multiple tests were used to increase the number of assessments in some cases. Water and plain bread (consisting only of wheat starch and water) were served as palate neutralizer. The assessors were selected, trained, and monitored according to the respective German standard (DIN 10961:1996-08). The assessors were trained to differentiate changes in sodium chloride concentration levels of 0.03%. It was also confirmed by a test that sodium chloride in potato puree or sour cream could be differentiated if no CMC was present. The test room was equipped according to the requirements of the German standard DIN 10962:1997.

### Viscosity

The rheological method is applicable for solutions with viscosities between 1 and 40,000 mPas (Rheometer: Haake RS1 with a cylinder system Z34 DIN, shear rate 10.0 s⁻¹). The Haake RS1 viscometer is commercially available as HAAKE RheoStress® 1 from Thermo Electron (Karlsruhe GmbH), Germany. Viscosities above 40,000 mPas can be determined accordingly (Rheometer: Haake RS 1 with a cone and plate geometry, shear rate 10.0 s⁻¹). The viscosity of the samples was measured at 20° C±0.1° C. The sample was put into the geometry and allowed to equilibrate to the temperature for 10 min at 20° C±0.1° C. (without shear). Afterwards, a shear rate of 10.0 s⁻¹ was adjusted within 1 min and then the measurement started immediately. After 2 min the measurement was stopped.

### Carboxymethyl Cellulose

The Comparative CMC-1 (the sodium salt of carboxymethyl cellulose) has a degree of carboxymethyl substitution per anhydroglucose unit (DS) of 0.9, measured according to ASTM D 1439-03 “Standard Test Methods for Sodium Carboxymethylcellulose; Degree of Etherification, Test Method B: Nonaqueous Titration” and a viscosity of 41mPa•s, measured as a 2 weight percent aqueous solution using the Haake RS 1 viscometer as described above.

The CMC-2 (the sodium salt of carboxymethyl cellulose) has a degree of carboxymethyl substitution per anhydroglucose unit (DS) of 0.9, measured as indicated above and a viscosity of 2635 mPa•s, measured as a 2 weight percent aqueous solution using the Haake RS 1 viscometer as described above.

### Aqueous CMC Solutions (Comparative Examples)

Solutions were prepared at room temperature. CMC-1 or CMC-2 was added while stirring at 1500 rpm within 1 min and stirred for additional 90 min at 1000 rpm. Afterwards, the solutions were stored until all air bubbles had disappeared (Stirrer: IKA Eurostar control-visc 6000). The composition of the aqueous solutions is listed in Table 1 below.

TABLE 1

| | Control | Sample 1 | Sample 2 | Sample 3 | Sample 4 |
|---|---|---|---|---|---|
| | (wt. %) | (wt. %) | (wt. %) | (wt. %) | (wt. %) |
| 0.8% aq. | — | 99.70 | 99.75 | 99.78 | 99.80 |
| CMC-1 | | | | | |
| solution | | | | | |
| Sodium | 0.30 | 0.30 | 0.25 | 0.22 | 0.20 |
| chloride | | | | | |
| Water | 99.70 | — | — | | — |
| Viscosity | 1 | 6 | 6 | 6 | 6 |
| of solution | | | | | |
| (mPa · s) | | | | | |

TABLE 2

| | Control | Sample 1 | Sample 2 | Sample 3 |
|---|---|---|---|---|
| | (wt. %) | (wt. %) | (wt. %) | (wt. %) |
| 0.2% aq. | — | 99.70 | 99.75 | 99.80 |
| CMC-2 | | | | |
| solution | | | | |
| Sodium | 0.30 | 0.30 | 0.25 | 0.20 |
| chloride | | | | |
| Water | 99.70 | — | — | — |
| Viscosity | 1 | 6 | 6 | 6 |
| of solution | | | | |
| (mPa · s) | | | | |

Potato Puree Samples with CMC-1 (Comparative Example, but Not Prior Art)

Potato puree made of potato flakes to which no sodium chloride had been added (“NaCl-fee potato puree”) was used as reference food. The NaCl-free potato puree had a viscosity of about 36,500 mPa•s, measured at 20° C. using the Haake RS1 viscometer as described above.

Sodium chloride was added to the NaCl-free potato puree in amounts listed in Table 3 below. The addition of CMC-1 did not have an increasing or otherwise significant impact on the viscosity of the potato puree; the total viscosity was 23,100, i.e. 37% lower than in the Control. It should be noted that the measured lower viscosity in Sample 1 in Table 3 below was not caused by the addition of CMC-1, but was rather due to the somewhat inhomogeneous nature of potato puree. The samples were prepared the day before the sensory test as followed: tap water was cooked to the boiling point and then weighed into a beaker. The dry components (potato flakes, sodium chloride, and CMC where applicable) were blended and then added to the hot water while stiffing gently with an egg whisker. After the addition, the potato puree samples including the control samples were stirred gently with an egg whisker for 1 min to avoid destruction of the puree structure (assessors should not be able to distinguish the samples with or without CMC and/or sodium chloride from observation of the texture). The samples were stored at 4° C. in the refrigerator overnight. The next day, the samples were allowed to adjust to room temperature, and then tap water was added to balance the difference of the evaporated water. The samples were stirred with an egg whisker for 1 minute. Directly before the sensory test, samples were gently stirred with the egg whisker again. The composition of the potato puree samples is listed in Table 3 below.

TABLE 3

| | Control | Sample 1 | Sample 2 | Sample 3 | Sample 4 |
|---|---|---|---|---|---|
| | (wt. %) | (wt. %) | (wt. %) | (wt. %) | (wt. %) |
| CMC-1 | — | 0.8 | 0.8 | 0.8 | 0.8 |
| NaCl | 0.30 | 0.30 | 0.25 | 0.22 | 0.20 |
| Water | 83.08 | 82.42 | 82.46 | 82.48 | 82.50 |
| NaCl-free | 16.62 | 16.48 | 16.49 | 16.50 | 16.50 |
| potato flakes | | | | | |
| Viscosity | 36,500 | 23,100 | — | — | — |
| of sample | | | | | |
| (mPa · s) | | | | | |

Sour Cream Samples with CMC-2 (Example 1)

Sour cream to which no sodium chloride had been added (“NaCl-fee sour cream”) was used as reference food. The NaCl-free sour cream had a viscosity of about 7000 mPa•s, measured at 20° C. using the Haake RS1 viscometer as described above.

Sodium chloride was added to the NaCl-free sour cream in amounts listed in Table 4 below as a dry blend together with CMC-2 giving 0.2% CMC-2 in the final sour cream. The addition of CMC-2 did not have a significant impact on the viscosity of the sour cream; the total viscosity was increased only about 10%. The samples were prepared the day before the sensory evaluation. The dry components were added to the sour cream while stirring with an egg whisker. After addition, the samples including the control samples were stirred gently with an egg whisker for 1 min to avoid destruction of the sour cream structure (assessors should not be able to distinguish the samples with or without CMC and/or sodium chloride from observation of the texture). The samples were stored at 4° C. in the refrigerator overnight. The next day, the samples were allowed to adjust to room temperature. Directly before the sensory test, samples were stirred with the egg whisker again. The composition of the sour cream samples is listed in Table 4 below.

TABLE 4

| | Control 1 | Sample 1 | Sample 2 | Sample 3 | Sample 4 | Sample 5 | Control 2 |
|---|---|---|---|---|---|---|---|
| | (wt. %) | (wt. %) | (wt. %) | (wt. %) | (wt. %) | (wt. %) | (wt. %) |
| CMC-2 | — | 0.2 | 0.2 | 0.2 | 0.2 | 0.2 | — |
| NaCl | 0.30 | 0.30 | 0.25 | 0.20 | 0.15 | 0.10 | 0.15 |
| NaCl-free sour cream | 99.7 | 99.5 | 99.55 | 99.6 | 99.65 | 99.65 | 99.85 |
| Viscosity of sample | 6,700 | 7,400 | | | | | |
| (mPa · s) | | | | | | | |

A triangular test according to ISO 4120:2001 was done as described above to do a sensory evaluation of the aqueous solutions listed in Tables 1 and 2 above, of the potato puree samples listed in Table 3 above and of the sour cream samples of Example 1 listed in Table 4 above. The assessors were selected, trained, and monitored according to the respective German standard (DIN 10961:1996-08).

TABLE 5
Sensory triangular Test with Aqueous Solutions of CMC-1 (Comparative)

| | | Number of assessors | Number of assessors |
|---|---|---|---|
| | | who identified | who did not identify |
| Sample A | Sample B | the odd Sample | the odd Sample |
| Control in Table 1 | Sample 1 in Table 1 | 8 | 0 |
| (water + 0.30% NaCl) | (0.80% CMC-1 + 0.30% NaCl) | | |
| Control in Table 1 | Sample 2 in Table 1 | 5 | 3 |
| (water + 0.30% NaCl) | (0.80% CMC-1 + 0.25% NaCl) | | |
| Control in Table 1 | Sample 3 in Table 1 | 5 | 3 |
| (water + 0.30% NaCl) | (0.80% CMC-1 + 0.22% NaCl) | | |
| Control in Table 1 | Sample 4 in Table 1 | 5 | 3 |
| (water + 0.30% NaCl) | (0.80% CMC-1 + 0.20% NaCl) | | |

In the test represented by Table 5, all assessors identified the odd sample at equal concentrations (Control in comparison with Sample 1). 7 out of the 8 assessors found Sample 1 with CMC-1 more salty than the Control. However, when the concentration of sodium chloride was decreased (see Samples 2, 3 and 4), the panelists found the Control to be saltier. There was no range of concentrations where the Control (Sample A) and a Sample with CMC-1 (Sample B) were found to be equally salty.

TABLE 6
Sensory triangular Test with Potato Puree (PP)
(Comparative Example, but not prior art)

| | | Number of assessors | Number of assessors |
|---|---|---|---|
| | | who identified | who did not identify |
| Sample A | Sample B | the odd Sample | the odd Sample |
| Control in Table 3 | Sample 1 in Table 3 | 5 | 3 |
| (PP + 0.30% NaCl) | (0.80% CMC-1 in | | |
| | PP + 0.30% NaCl) | | |
| Control in Table 3 | Sample 2 in Table 3 | 2 | 6 |
| (PP + 0.30% NaCl) | (0.80% CMC-1 in | | |
| | PP + 0.25% NaCl) | | |
| Control in Table 3 | Sample 3 in Table 3 | 3 | 5 |
| (PP + 0.30% NaCl) | (0.80% CMC-1 in | | |
| | PP + 0.22% NaCl) | | |
| Control in Table 3 | Sample 4 in Table 3 | 5 | 3 |
| (PP + 0.30% NaCl) | (0.80% CMC-1 in | | |
| | PP + 0.20% NaCl) | | |

In the test represented by Table 6, the majority of the assessors noticed a significant difference between Sample 1 having the composition as listed in Table 3 and the Control at equal salt concentration. When the NaCl content was reduced by 17% and 27% respectively (see Samples 2 and 3), the majority of the assessors could not find a significant difference between the Control and the Sample with a reduced NaCl content. Only when the NaCl content in the Samples was further decreased (Sample 4 had a 33% lower NaCl content than the Control), the majority of the assessors could find a significant difference between the Control and the Sample; 3 out of the 8 assessors described the Control as saltier than Sample 4.

TABLE 7
Sensory triangular Test with Aqueous Solutions of CMC-2 (Comparative)

| | | Number of assessors | Number of assessors |
|---|---|---|---|
| | | who identified | who did not identify |
| Sample A | Sample B | the odd Sample | the odd Sample |
| Control in Table 2 | Sample 1 in Table 2 | 3 | 4 |
| (water + 0.30% NaCl) | (0.2% CMC-2 + 0.30% NaCl) | | |
| Control in Table 2 | Sample 2 in Table 2 | 3 | 4 |
| (water + 0.30% NaCl) | (0.2% CMC-2 + 0.25% NaCl) | | |
| Control in Table 2 | Sample 3 in Table 2 | 7 | 0 |
| (water + 0.30% NaCl) | (0.2% CMC-2 + 0.20% NaCl) | | |

In the test represented in Table 7, the majority of the panelists could not identify the odd sample when testing the Control and Sample 1, which had both the same NaCl content or when testing the Control and Sample 2, the latter had 17% less NaCl. However, all assessors designated the Control as being saltier than Sample 3, which contained 33% less NaCl than the Control.

TABLE 8
Sensory triangular Test with Sour Cream (SC) (Example 2)

| | | Number of assessors | Number of assessors |
|---|---|---|---|
| | | who identified | who did not identify |
| Sample A | Sample B | the odd Sample | the odd Sample |
| Control 1 in Table 4 | Sample 1 in Table 4 | 5 | 3 |
| (SC + 0.30% NaCl) | (0.20% CMC-1 in | | |
| | SC + 0.30% NaCl)* | | |
| Control 1 in Table 4 | Sample 2 in Table 4 | 5 | 3 |
| (SC + 0.30% NaCl) | (0.20% CMC-1 in | | |
| | SC + 0.25% NaCl)* | | |
| Control 1 in Table 4 | Sample 3 in Table 4 | 2 | 6 |
| (SC + 0.30% NaCl) | (0.20% CMC-1 in | | |
| | SC + 0.20% NaCl) | | |
| Control 1 in Table 4 | Sample 4 in Table 4 | 4 | 3 |
| (SC + 0.30% NaCl) | (0.20% CMC-1 in | | |
| | SC + 0.15% NaCl) | | |
| Control 1 in Table 4 | Sample 4 in Table 4 | 6 | 1 |
| (SC + 0.30% NaCl)* | (0.20% CMC-1 in | | |
| | SC + 0.10% NaCl) | | |

*Was found to be saltier

In the test represented by Table 8, the majority of the assessors noticed a significant difference between Sample 1 having the composition as listed in Table 4 and Control 1 at equal NaCl concentration. Sample 1 was found to be saltier. Also Sample 2 was found to be saltier than Control 1 although Sample 2 contained 17% less NaCl than Control 1. The majority of the assessors did not notice a significant difference between Control 1 and

Sample 3 that contained 33% less NaCl than Control 1. Only 4 out of 7 assessors could differentiate between Control 1 and Sample 4, although Sample 4 contained 50 percent less NaCl than Control 1.

Assessors could clearly differentiate between these concentrations if no CMC-2 was present as shown in the Table 9 below:

TABLE 9

| | | Number of assessors | Number of assessors |
|---|---|---|---|
| | | who identified | who did not identify |
| Sample A | Sample B | the odd Sample | the odd Sample |
| Control 1 in Table 4 | Control 2 in Table 4 | 6 | 0 |
| (SC + 0.30% NaCl) | SC + 0.15% NaCl) | | |

The results in Table 8 in comparison with the results in Table 6 illustrate that a carboxymethyl cellulose having a viscosity of from 200 to 15,000 mPa•s surprisingly is more effective for reducing the amount of an alkali metal chloride in a fluid or solid food composition without reducing the perceived saltiness of the food composition than a carboxymethyl cellulose that has a viscosity of less than 200 mPa•s. Although the CMC-2 concentration in the food composition listed in Table 8 is only 0.2%, the majority of the assessors found the Control (without CMC) only saltier than the Sample (with CMC-2 having a viscosity of 2635 mPa•s, measured as a 2 weight percent aqueous solution) when the Sample contained 50 percent less NaCl than the Control. In the food composition listed in Table 6, where the CMC-1 concentration is 0.8%, the majority of the assessors found the Control (without CMC) saltier than the Sample (with CMC-1 having a viscosity of 41 mPa•s, measured as a 2 weight percent aqueous solution) when the Sample contained 33 percent less NaCl than the Control.

It should be noted that the use of a carboxymethyl cellulose that has a viscosity of less than 200 mPa•s for reducing the amount of an alkali metal chloride in a fluid or solid food composition without reducing the perceived saltiness of the food composition is not prior art either. Carboxymethyl cellulose having a viscosity of less than 200 mPa•s has a significantly different effect in solid food compositions or in fluid food compositions which have a viscosity of at least 10 mPa•s (when measured in the absence of the carboxymethyl cellulose at 20° C. using a Haake RS1 viscometer at 10.0 s⁻¹) than in plain water.

1. A salt composition consisting of
a) an alkali metal chloride,
b) a carboxymethyl cellulose, and
c) 0 to 75 percent, based on the total weight of the salt composition, of one or more additional ingredients, being different from alkali metal chloride and carboxymethyl cellulose,
wherein the carboxymethyl cellulose has a viscosity of from 200 to 15,000 mPa•s, measured as a 2 weight percent aqueous solution at 20° C. using a Haake RS 1 viscometer with a cylinder system Z34 DIN at 10.0 s⁻¹ and the weight ratio of [carboxymethyl cellulose/alkali metal chloride] is from [0.2/1.0] to [4.0/1.0].

2. The composition of claim 1 wherein the carboxymethyl cellulose has a viscosity of from 200 to 5000 mPa•s, measured as a 2 weight percent aqueous solution at 20° C.

3. The composition of claim 1 wherein the amount of one or more additional ingredients is from 0 to 50 percent, based on the total weight of the salt composition.

4. The salt composition of claim 1 wherein the weight ratio of [carboxymethyl cellulose/alkali metal chloride] is from [0.2/1.0] to [2.0/1.0].

5. The salt composition of claim 4 wherein the weight ratio of [carboxymethyl cellulose/alkali metal chloride] is from [0.5/1.0] to [1.5/1.0].

6. The salt composition of claim 1 wherein the total amount of the alkali metal chloride and the carboxymethyl cellulose is at least 80 percent, based on the total weight of the salt composition.

7. The salt composition of claim 1 wherein the alkali metal chloride is sodium chloride.

8. A method of increasing the perceived saltiness provided by an alkali metal chloride in a fluid or solid food composition comprising the step of incorporating a carboxymethyl cellulose having a viscosity of from 200 to 15,000 mPa•s, measured as a 2 weight percent aqueous solution at 20° C. using a Haake RS 1 viscometer with a cylinder system Z34 DIN at 10.0 s⁻¹, in combination with an alkali metal chloride in the fluid or solid food composition in such amount that the weight ratio [carboxymethyl cellulose/alkali metal chloride] in the food composition is from [0.1/1.0] to [4.0/1.0], with the proviso that the fluid food composition has a viscosity of at least 10 mPa•s, when measured in the absence of the carboxymethyl cellulose at 20° C. using a Haake RS1 viscometer at 10.0 s⁻¹.

9. A method of reducing the amount of an alkali metal chloride in a fluid or solid food composition comprising the steps of:
incorporating a fraction of an amount of alkali metal chloride that is recommended in a given recipe for the food composition resulting in a loss of saltiness, and
incorporating carboxymethyl cellulose having a viscosity of from 200 to 15,000 mPa•s, measured as a 2 weight percent aqueous solution at 20° C. using a Haake RS 1 viscometer with a cylinder system Z34 DIN at 10.0 s⁻¹ in the fluid or solid food composition in such amount that the weight ratio [carboxymethyl cellulose/alkali metal chloride] in the food composition is from [0.1/1.0] to [4.0/1.0] to compensate for the lost perception of saltiness,
with the proviso that the fluid food composition has a viscosity of at least 10 mPa•s, when measured in the absence of the carboxymethyl cellulose at 20° C. using a Haake RS1 viscometer at 10.0 s⁻¹.

10. The method of claim 8 wherein the carboxymethyl cellulose is incorporated in a fluid food composition which has a viscosity of at least 10 mPa•s, when measured in the absence of the carboxymethyl cellulose at 20° C., and the carboxymethyl cellulose is incorporated into the fluid food composition in such amount that the viscosity of the fluid composition comprising the carboxymethyl cellulose is not more than 100 percent higher than the viscosity of the fluid composition without the carboxymethyl cellulose.

11. The method of claim 8 wherein the carboxymethyl cellulose has a viscosity of from 200 to 5000 mPa•s, measured as a 2 weight percent aqueous solution at 20° C.

12. The method of claim 8 wherein the carboxymethyl cellulose and the alkali metal chloride are added in a weight ratio of [carboxymethyl cellulose/alkali metal chloride] of from [0.2/1.0] to [4.0/1.0] to the food composition.

13. The method of claim 12 wherein the carboxymethyl cellulose and the alkali metal chloride are added in a weight ratio of [carboxymethyl cellulose/alkali metal chloride] of from [0.2/1.0] to [2.0/1.0] to the food composition.

14. The method of claim 13 wherein the carboxymethyl cellulose and the alkali metal chloride are added in a weight ratio of [carboxymethyl cellulose/alkali metal chloride] of from [0.5/1.0] to [1.5/1.0] to the food composition.

15. (canceled)

16. The composition of claim 1 wherein
the carboxymethyl cellulose has a viscosity of from 200 to 5000 mPa®s, measured as a 2 weight percent aqueous solution at 20° C., the weight ratio of [carboxymethyl cellulose/alkali metal chloride] is from [0.5/1.0] to [1.5/1.0],
the total amount of the alkali metal chloride and the carboxymethyl cellulose is at least 80 percent, based on the total weight of the salt composition, and
the alkali metal chloride is sodium chloride.

17. The method of claim 9 wherein the carboxymethyl cellulose is incorporated in a fluid food composition which has a viscosity of at least 10 mPa•s, when measured in the absence of the carboxymethyl cellulose at 20° C., and the carboxymethyl cellulose is incorporated into the fluid food composition in such amount that the viscosity of the fluid composition comprising the carboxymethyl cellulose is not more than 100 percent higher than the viscosity of the fluid composition without the carboxymethyl cellulose.

18. The method of claim 9 wherein the carboxymethyl cellulose has a viscosity of from 200 to 5000 mPa•s, measured as a 2 weight percent aqueous solution at 20° C.

19. The method of claim 9 wherein the carboxymethyl cellulose and the alkali metal chloride are added in a weight ratio of [carboxymethyl cellulose/alkali metal chloride] of from [0.2/1.0] to [4.0/1.0] to the food composition.

20. The method of claim 19 wherein the carboxymethyl cellulose and the alkali metal chloride are added in a weight ratio of [carboxymethyl cellulose/alkali metal chloride] of from [0.2/1.0] to [2.0/1.0] to the food composition.

21. The method of claim 20 wherein the carboxymethyl cellulose and the alkali metal chloride are added in a weight ratio of [carboxymethyl cellulose/alkali metal chloride] of from [0.5/1.0] to [1.5/1.0] to the food composition.
